(19) United States
(12) Patent Application Publication
(10) Pub. No.: US 2025/0290905 A1
(43) Pub. Date: Sep. 18, 2025

(54) Urea Pyrolysis Test Divice and Method

(71) Applicants: Xi'an Thermal Power Research Institute Co., Ltd, Shaanxi (CN); Northwestern Polytechnical University, Shaanxi (CN)

(72) Inventors: Zhi Luo, Shaanxi (CN); Chen Dong, Shaanxi (CN); Yudong He, Shaanxi (CN); Wei Fan, Shaanxi (CN); Zhonghua Jin, Shaanxi (CN); Jin Zheng, Shaanxi (CN); Dong Pan, Shaanxi (CN); Xiaobing Wang, Shaanxi (CN); Tong Shang, Shaanxi (CN); Shuhong Li, Shaanxi (CN); Zhuang Yuan, Shaanxi (CN); Kai Shu, Shaanxi (CN); Shiji Yang, Shaanxi (CN); Xiaotao Xu, Shaanxi (CN); Xiaogang Yang, Shaanxi (CN); Lei Shi, Shaanxi (CN)

(21) Appl. No.: 18/619,961

(22) Filed: Mar. 28, 2024

(30) Foreign Application Priority Data
Mar. 13, 2024 (CN) 202410288824.7

(51) Int. Cl. G01N 31/00

(52) U.S. Cl. CPC G01N 31/00

(57) ABSTRACT

The present disclosure provides a urea pyrolysis test device and method. The urea pyrolysis test device includes a pyrolysis reactor, a urea preparation unit and an injection unit, where the pyrolysis reactor is provided with a flue therein, the urea preparation unit is configured to prepare a urea solution, and the injection unit is connected to the urea preparation unit and includes a plurality of nozzles extending into the flue so as to spray the urea solution into the flue.

### CROSS-REFERENCE TO RELATED APPLICATION

The application is based on and claims priority to Chinese Patent Application No. 2024102888247, filed on Mar. 13, 2024, the entire content of which is incorporated herein by reference.

### TECHNICAL FIELD

The present disclosure relates to the technical field of a pyrolysis apparatus, and specifically relates to a urea pyrolysis test device and method.

### BACKGROUND

Urea (CH₄N₂O) pyrolysis technology with direct injection is to spray an atomized urea solution into a selective-catalytic-reduction (SCR) inlet flue, and pyrolyze the urea solution into a reducing agent which is required for SCR denitration by heat of high temperature flue gas in the SCR inlet flue. In the related art, a direct injection system provided in a urea pyrolysis furnace includes a water dilution device, a metering device, a distribution device, a urea solution injector, etc. However, it is generally determined to parameters of the pyrolysis system according to experiences in the related art, lacking test devices to verify these parameters, thereby reversely affecting industrial production.

### SUMMARY

The present disclosure is provided to at least solve the problems in the related art to a certain degree. For this, the present disclosure provides in embodiments a urea pyrolysis test device which can verify urea pyrolysis parameters, thereby improving industrial production efficiency.

The present disclosure further provides in embodiments a urea pyrolysis test method.

According to embodiments of the present disclosure, the urea pyrolysis test device includes: a pyrolysis reactor, provided with a flue therein; a urea preparation unit, configured to prepare a urea solution; and an injection unit, connected to the urea preparation unit and including a plurality of nozzles extending into the flue so as to spray the urea solution into the flue.

The urea pyrolysis test device provided in embodiments of the present disclosure can verify urea pyrolysis parameters, thereby improving industrial production efficiency.

In some embodiments, the flue includes a flue-inlet section and a reaction section communicated with each other, the injection unit is arranged at the flue-inlet section, and the flue-inlet section is provided with an air inlet adapted to be communicated with the atmosphere and a flue gas inlet adapted to be communicated with a boiler.

In some embodiments, the flue further includes a transition section arranged between the flue-inlet section and the reaction section, a plurality of first guide plates are arranged, at intervals in the flue, at a joint of the transition section and the flue-inlet section.

In some embodiments, the first guide plate is an arc-shaped plate.

In some embodiments, the first guide plate is arranged orthogonally relative to a direction of the joint of the transition section and the flue-inlet section.

In some embodiments, a plurality of second guide plates are arranged, at intervals in the flue, at a joint of the transition section and the reaction section.

In some embodiments, the second guide plate is a flat plate and arranged obliquely relative to an axial direction of the reaction section.

In some embodiments, the urea preparation unit includes: a dissolving tank; a first pump, connected to the plurality of nozzles, and connected to the dissolving tank; and a first valve connected to the first pump.

In some embodiments, the urea pyrolysis test device further includes a dilution unit, wherein the dilution unit includes: a water storage tank, a second pump, a second valve and a mixer connected sequentially, wherein an outlet of the first valve is connected to the mixer, and an outlet of the mixer is connected to the plurality of nozzles.

In some embodiments, the urea pyrolysis test device further includes a gas blowing part, with an inlet adapted to be connected to a compressed gas source and an outlet arranged between the mixer and the nozzles; and a third valve, arranged between the gas blowing part and the nozzles.

In some embodiments, the urea pyrolysis test device further includes a gas blowing part, with an inlet adapted to be connected to a compressed gas source and an outlet arranged between the mixer and the nozzles; and a third valve, arranged between the gas blowing part and the nozzles.

The urea pyrolysis test method according to embodiments of the present disclosure includes the following steps: switching on an air inlet and communicating a flue gas inlet with a flue gas outlet so as to deliver flue gas into a pyrolysis reactor via the flue gas inlet, monitoring a temperature rise rate at the flue gas inlet to be maintained within a first preset condition; preparing a urea solution with a urea preparation unit, and injecting the prepared urea solution into the pyrolysis reactor at a preset flow rate; and initiating a gas blowing part to deliver compressed air into an injection unit at a preset pressure.

The urea pyrolysis test method provided in embodiments of the present disclosure can flexibly adjust test conditions according to a temperature, concentration and components of flue gas, thereby improving applicability, flexibility and accuracy of the test.

### BRIEF DESCRIPTION OF THE DRAWINGS

FIG. 1 is a structure diagram showing a urea pyrolysis test device according to Examples of the present disclosure.

Drawing references:
pyrolysis reactor 1, flue 11, flue-inlet section 111, air inlet 1111, flue gas inlet 1112, transition section 112, reaction section 113;
urea preparation unit 2, dissolving tank 21, first pump 22, first valve 23, flow controller 24, fourth valve 25, fifth valve 26;
injection unit 3, nozzle 31, first guide plate 7, second guide plate 8;
dilution unit 4, water storage tank 41, second pump 42, second valve 43, mixer 44, first flowmeter 45, sixth valve 46, seventh valve 47;
gas blowing part 5, third valve 6.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure.

According to examples of the present disclosure, a urea pyrolysis test device may include: a pyrolysis reactor 1, a urea preparation unit 2 and an injection unit 3, where the pyrolysis reactor 1 is provided with a flue 11 therein, the urea preparation unit 2 is configured to prepare a urea solution, and the injection unit 3 is connected to the urea preparation unit 2 and includes a plurality of nozzles 31 extending into the flue 11 so as to spray the urea solution into the flue 11.

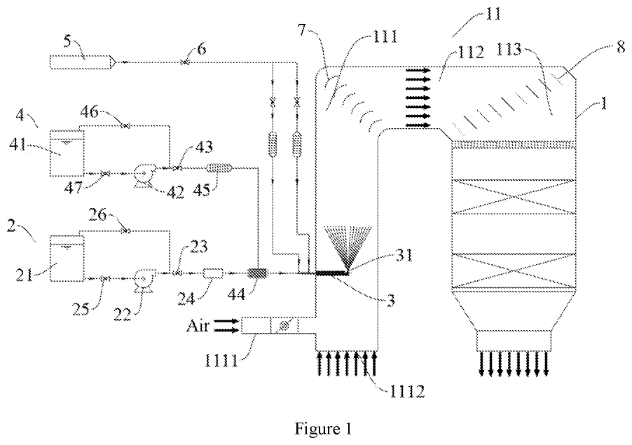

Specifically, as shown in FIG. 1, the injection unit 3 goes into the flue 11, and the urea solution prepared by the urea preparation unit 2 is sprayed into the flue 11 via the injection unit 3.

The urea pyrolysis test device in examples of the present disclosure, with the pyrolysis reactor 1, urea preparation unit 2 and injection unit 3 provided therein, can perform urea pyrolysis test according to parameters to be verified, so as to confirm accuracy of the parameters, thereby improving industrial production efficiency.

In some examples, the flue 11 includes a flue-inlet section 111 and a reaction section 113 communicated with each other. The injection unit 3 is arranged at the flue-inlet section 111, and the flue-inlet section 111 is provided with an air inlet 1111 adapted to be communicated with the atmosphere and a flue gas inlet 1112 adapted to be communicated with a boiler.

Specifically, as shown in FIG. 1, the flue-inlet section 111 is provided with the air inlet 1111 and the flue gas inlet 1112, where the air inlet 1111 is communicated to a compressed-air source, and the flue gas inlet 1112 is communicated to an outlet of a boiler or economizer. The air can accelerate flue gas flowing within the flue 11, thereby improving efficiency of the urea pyrolysis test.

In some examples, a valve may be arranged at the air inlet 1111 to control air volume into the flue 11, so as to adjust the temperature of the flue gas.

In some examples, the flue 11 may further include a transition section 112 which is arranged between the flue-inlet section 111 and the reaction section 113, and at a joint of the transition section 112 and the flue-inlet section 111, there is provided a plurality of first guide plates 7 arranged at intervals in the flue 11.

Specifically, as shown in FIG. 1, an inlet of the transition section 112 is communicated with an outlet of the flue-inlet section 111, and an outlet of the transition section 112 is communicated with an inlet of the reaction section 113, and a plurality of the first guide plates 7 are arranged at the joint of the transition section 112 and the flue-inlet section 111, where the plurality of the first guide plates 7 are arranged at intervals in the flue 11. In some examples the plurality of the first guide plates 7 are arranged in an orthogonal direction to the joint of the transition section 112 and the flue-inlet section 111. In some examples, the first guide plate 7 is of arc shape. By providing the first guide plate 7, the flue gas in the flue-inlet section 111 can smoothly flow into the transition section 112, thereby avoiding eddies which may be generated at the joint of the transition section 112 and the flue-inlet section 111 to negatively affect pyrolysis efficiency. The first guide plate 7 with arc-shape improves the smoothness of the flue gas flowing, and setting the plurality of the first guide plates 7 further makes the flue gas flow into the transition section 112 evenly.

In some examples, at a joint of the transition section 112 and the reaction section 113 there is provided a plurality of second guide plates 8 arranged at intervals in the flue 11.

Specifically, as shown in FIG. 1, a plurality of the second guide plates 8 are arranged at the joint of the transition section 112 and the reaction section 113, where the plurality of the second guide plates 8 are arranged at intervals in the flue 11. In some examples, the plurality of the second guide plates 8 are arranged obliquely, for example, in an oblique direction to an axial direction of the reaction section 113. In some examples, the second guide plate 8 is a flat plate and is arranged obliquely. By providing the second guide plate 8, the flue gas in the transition section 112 can smoothly flow into the reaction section 113, thereby avoiding eddies which may be generated at the joint of the transition section 112 and the reaction section 113 to negatively affect pyrolysis efficiency. The second guide plate 8 arranged obliquely with flat shape ensures the flue gas contacting with catalyst evenly, thereby improving pyrolysis efficiency of urea.

In some examples, the urea preparation unit 2 includes a dissolving tank 21, a first pump 22 and a first valve 23, where the first pump 22 is connected to the dissolving tank 21, the first valve 23 is connected to the first pump 22, and the first pump 22 is connected to the plurality of nozzles 31.

Specifically, as shown in FIG. 1, an outlet of the dissolving tank 21 is communicated with an inlet of the first pump 22, an outlet of the first pump 22 is communicated with an inlet of the first valve 23, and an outlet of the first valve 23 is communicated with the plurality of nozzles 31.

In some examples, the urea preparation unit 2 further includes a flow controller 24, a fourth valve 25 and a fifth valve 26, where an inlet of the flow controller 24 is communicated with the outlet of the first valve 23, and an outlet of the flow controller 24 is communicated with the injection unit 3, thus to control an injection amount of the urea solution via the arranged flow controller 24, thereby satisfying verifications of different test parameters. The fourth valve 25 and the fifth valve 26, arranged at different pipes, are both communicated with the dissolving tank 21, where an outlet of the fourth valve 25 is communicated with the first pump 22, and an outlet of the fifth valve 26 is communicated with the first valve 23. The urea solution can be pressured when passing through the fourth valve 25 and the first pump 22 and flowing into the injection unit 3.

In some examples, the urea pyrolysis test device further includes a dilution unit 4 including a water storage tank 41, a second pump 42, a second valve 43 and a mixer 44 connected sequentially, where the outlet of the first valve 23 is communicated with the mixer 44 and an outlet of the mixer 44 is communicated with the plurality of nozzles 31 individually.

In some examples, the water storage tank 41 stores demineralized water therein.

Specifically, an inlet of the mixer 44 is communicated with the outlet of the flow controller 24, and the outlet of the mixer 44 is communicated with the injection unit 3. In some examples, the dilution unit 4 further includes a first flowmeter 45, a sixth valve 46, and a seventh valve 47, where the sixth valve 46 and the seventh valve 47 are both communicated with the water storage tank 41, an outlet of the sixth valve 46 is communicated with an inlet of the second valve 43, an inlet of the seventh valve 47 is communicated with the water storage tank 41, an outlet of the seventh valve 47 is communicated with an inlet of the second pump 42. The demineralized water can be pressured when passing through the seventh valve 47 and the second pump 42 and flowing into the mixer 44.

The urea pyrolysis test device in examples of the present disclosure, with the dilution unit 4 provided therein, can dilute the urea solution thus adjusting the concentration of the urea solution entering into the flue 11, ensuring atomization effects at the nuzzles 31, thereby improving efficiency of urea pyrolysis.

In some examples, the pyrolysis test device further includes a gas blowing part 5, with an inlet adapted to be communicated with the compressed-air source and an outlet arranged between the mixer 44 and the nuzzles 31.

Specifically, as shown in FIG. 1, the outlet of the gas blowing part 5 may be split into a first pipeline and a second pipeline, which are both communicated with the nuzzles 31. The compressed air intercommunicates with the plurality of nuzzles 31 via the first pipeline, where the compressed air in the first pipeline serves as cooling air to cool the nuzzles 31, while the compressed air in the second pipeline serves as atomizing air to push the urea solution to the nuzzles 31 to atomize the same, and to spray it into the flue 11.

The directly spraying urea system according to examples of the present disclosure, with the gas blowing part 5 provided therein, not only improves atomization effects on the urea solution, but also cools the nuzzles 31 down, thereby increasing efficiency of urea pyrolysis and prolonging service life of the nuzzles 31.

In some examples, the pyrolysis test device further includes a third valve 6 which is arranged between the gas blowing part 5 and the nuzzles 31. By controlling angles of the third valve 6 opening, pressures of the atomizing air provided to a pyrolysis spray gun for urea can be adjusted, thereby adjusting a spray velocity of the urea solution.

Operation of the pyrolysis test device according to examples of the present disclosure will be described below with reference to FIG. 1.

A flue gas temperature, urea concentration and injection speed were set according to processing parameters for test. The flue gas entered the flue 11 through the flue gas inlet 1112, and air entered the flue 11 through the air inlet 1111, and air volume into the flue 11 was controlled by controlling the opening degree of the valve at the air inlet 1111, so as to adjust the temperature of the flue gas. The urea solution was mixed with the demineralized water in the mixer 44, and respective quantities of flow of the urea solution and the demineralized water were adjusted so as to adjust the urea concentration, and the urea injection speed was adjusted through the amount of atomizing air blown by the gas blowing part 5. After a set of parameters was tested, the spray pressure of urea solution was adjusted by changing the opening and closing of the fourth valve 25 and the fifth valve 26, and that of the demineralized water was adjusted by changing the opening and closing of the sixth valve 46 and the seventh valve 47.

After a set of parameters was verified, different parameters were validated through adjusting the opening, closing and opening degree of each valve.

According to examples of the present disclosure, the urea pyrolysis test method may include the following steps: S100-S 300.

At the S100, an air inlet is switched on and a flue gas inlet is communicated with a flue gas outlet so as to deliver flue gas into a pyrolysis reactor via the flue gas inlet, monitoring a temperature rise rate at the flue gas inlet to be maintained within a first preset condition.

It should be noted that at the S100, the valve of the air inlet is opened and then a connection pipe between the flue gas inlet and the flue gas inlet is enabled. After 5 minutes, the flue gas from the outlet of the boiler or economizer flows into the pyrolysis reactor, monitoring the temperature rise rate at the flue gas inlet to be maintained within the first preset condition by observing flue gas temperatures at the flue gas inlet and outlet of the pyrolysis reactor. For examples, the first preset condition may be as a temperature rise rate lower than 12° C./min and the flue gas temperature at the flue gas inlet being from 290° C. to 400° C.

If raising sharply, the temperature rise rate at the flue gas inlet may be adjusted by reducing the opening degree of the valve arranged ahead the flue gas inlet or increasing the inletting air amount.

At S200, a urea solution is prepared with a urea preparation unit, and the prepared urea solution is injected into the pyrolysis reactor at a preset flow rate.

In some examples, the dissolving tank may be provided with a heater. It should be noticed that for the urea solution preparation, the demineralized water with an appropriate amount is added into the dissolving tank and is heated to 50° C. with the heater in the dissolving tank. A proper amount of urea granules is then introduced, thus to obtain the urea solution with a certain concentration after evenly mixing, during which the heater is kept on with a set temperature of 40° C. All valves at urea circulation pipelines are opened, and after the urea granules dissolve, a gear pump is started to draw out the prepared urea solution from the dissolving tank, thus to provide the urea solution with high quantity of flow.

Valves arranged at pipelines connecting urea solution transferring pipelines and nuzzles are opened, and a flow rate of the urea solution is preset. For example, the preset flow rate may be 10 L/h. By observations on the pressure of the urea solution in the urea solution transferring pipeline, based on the pressure rises to 0.4 to 0.6 MPa, the preset flow rate is adjusted into 5 L/h to 30 L/h.

At the S300, a gas blowing part is initiated to deliver compressed air into an injection unit at a preset pressure.

It should be noted that valve arranged at compressed air pipeline is opened to transfer the compressed air to the flowmeter, and the valve of the compressed air ahead of the nuzzles is opened, and the pressure of the compressed air supplied into the nuzzles of urea pyrolysis is adjusted to 0.2 to 0.4 MPa by adjusting a relief valve in the compressed air pipeline. At this time, it is checked whether the state of the atomized urea solution sprayed by the pyrolysis spray gun is normal. If yes, the nuzzles are inserted into the flue of the pyrolysis reactor.

After the test is finished, water in the water storage tank is supplied, by the gear pump, to the nuzzles to flushing the nuzzles for 5 minutes, with the compressed air maintaining open.

In some example, the method for test may further test desorption effects for SO₃ and/or SO₂ at different temperatures, by introducing SO₃, SO₂ and/or other components into the flue gas and spraying alkaline matters into the flue.

The urea pyrolysis test method provided in examples of the present disclosure can flexibly adjust test conditions according to a temperature, concentration and components of flue gas, thereby improving applicability, flexibility and accuracy of the test.

In the specification, it should be understood that, the terms indicating orientation or position relationship such as “central”, “longitudinal”, “lateral”, “width”, “thickness”, “above”, “below”, “front”, “rear”, “right”, “left”, “vertical”, “horizontal”, “top”, “bottom”, “inner”, “outer”, “clockwise”, “counter-clockwise”, “axial”, “radial”, “circumferential” should be construed to refer to the orientation or position relationship as then described or as shown in the drawings. These terms are merely for convenience and concision of description and do not alone indicate or imply that the device or element referred to must have a particular orientation or must be configured or operated in a particular orientation. Thus, it cannot be understood to limit the present disclosure.

In addition, terms such as “first” and “second” are used herein for purposes of description and are not intended to indicate or imply relative importance or significance or impliedly indicate quantity of the technical feature referred to. Thus, the feature defined with “first” and “second” may comprise one or more this features. In the description of the present disclosure, “a plurality of” means two or more than two this features, unless specified otherwise.

In the present disclosure, unless specified or limited otherwise, the terms “mounted”, “connected”, “coupled”, “fixed” and the like are used broadly, and may be, for example, fixed connections, detachable connections, or integrated connections; may also be mechanical or electrical connections; may also be direct connections or indirect connections via intervening structures; may also be inner communications of two elements or mutual interaction between two elements, which can be understood by those skilled in the art according to specific situations.

In the present disclosure, unless specified or limited otherwise, a structure in which a first feature is “on” or “below” a second feature may be an embodiment in which the first feature is in direct contact with the second feature, or an embodiment in which the first feature and the second feature are contacted indirectly via an intermediation. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example”, “in a specific example” or “in some examples”, in various places throughout this specification are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined by those skilled in the art without contradiction.

Although explanatory embodiments have been shown and described, it would be appreciated by those skilled in the art that the above embodiments cannot be construed to limit the present disclosure, and changes, alternatives, and modifications can be made in the embodiments in the scope of the present disclosure.

What is claimed is:

1. A urea pyrolysis test device, comprising:
a pyrolysis reactor, provided with a flue therein;
a urea preparation unit, configured to prepare a urea solution; and
an injection unit, connected to the urea preparation unit and comprising a plurality of nozzles extending into the flue so as to spray the urea solution into the flue.

2. The urea pyrolysis test device according to claim 1, wherein the flue comprises a flue-inlet section and a reaction section communicated with each other, the injection unit is arranged at the flue-inlet section, and the flue-inlet section is provided with an air inlet adapted to be communicated with the atmosphere and a flue gas inlet adapted to be communicated with a boiler.

3. The urea pyrolysis test device according to claim 2, wherein the flue further comprises a transition section arranged between the flue-inlet section and the reaction section, a plurality of first guide plates are arranged, at intervals in the flue, at a joint of the transition section and the flue-inlet section.

4. The urea pyrolysis test device according to claim 3, wherein the first guide plate is an arc-shaped plate.

5. The urea pyrolysis test device according to claim 4, wherein the first guide plate is arranged orthogonally relative to a direction of the joint of the transition section and the flue-inlet section.

6. The urea pyrolysis test device according to claim 2, wherein a plurality of second guide plates are arranged, at intervals in the flue, at a joint of the transition section and the reaction section.

7. The urea pyrolysis test device according to claim 6, wherein the second guide plate is a flat plate and arranged obliquely relative to an axial direction of the reaction section.

8. The urea pyrolysis test device according to claim 1, wherein the urea preparation unit comprises:
a dissolving tank;
a first pump, connected to the plurality of nozzles, and connected to the dissolving tank; and
a first valve connected to the first pump.

9. The urea pyrolysis test device according to claim 8, further comprising a dilution unit, wherein the dilution unit comprises: a water storage tank, a second pump, a second valve and a mixer connected sequentially,
wherein an outlet of the first valve is connected to the mixer, and an outlet of the mixer is connected to the plurality of nozzles.

10. The urea pyrolysis test device according to claim 9, further comprising:
a gas blowing part, with an inlet adapted to be connected to a compressed gas source and an outlet arranged between the mixer and the nozzles; and
a third valve, arranged between the gas blowing part and the nozzles.

11. A urea pyrolysis test method, comprising the following steps:
switching on an air inlet and communicating a flue gas inlet with a flue gas outlet so as to deliver flue gas into a pyrolysis reactor via the flue gas inlet, monitoring a temperature rise rate at the flue gas inlet to be maintained within a first preset condition;
preparing a urea solution with a urea preparation unit, and injecting the prepared urea solution into the pyrolysis reactor at a preset flow rate; and
initiating a gas blowing part to deliver compressed air into an injection unit at a preset pressure.
